(19) United States
(12) Patent Application Publication
(10) Pub. No.: US 2026/0135890 A1
(43) Pub. Date: May 14, 2026

(54) SIGNALING SIZE AND ACCURACY OF A DATA BURST INCLUDING MEDIA DATA IN AN RTP HEADER EXTENSION FOR MEDIA STREAMING

(71) Applicant: QUALCOMM Incorporated, San Diego, CA (US)

(72) Inventors: Liangping Ma, San Diego, CA (US); Hyun Yong Lee, San Diego, CA (US)

(21) Appl. No.: 19/355,558

(22) Filed: Oct. 10, 2025

Related U.S. Application Data
(60) Provisional application No. 63/718,202, filed on Nov. 8, 2024.

(51) Int. Cl. H04L 65/1069; H04L 65/65

(52) U.S. Cl. CPC H04L 65/1069; H04L 65/65

(57) ABSTRACT

An example device sending media data includes: a memory configured to store media data; and a processing system implemented in circuitry and configured to: send a data burst including a set of protocol data units (PDUs) including media data via a network; and send a size value representing a size of the data burst and an accuracy value representing an accuracy of the size value. An example base station device includes a processing system implemented in circuitry and configured to: receive a size value representing a size of a data burst including a set of PDUs including media data and an accuracy value representing an accuracy of the size value; allocate base station resources for the data burst according to the size value and the accuracy value to form allocated base station resources; and use the allocated base station resources to receive the data burst via a network.

This application claims the benefit of U.S. Provisional Application No. 63/718,202, filed Nov. 8, 2024, the entire contents of which are hereby incorporated by reference.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to streaming media data over a network. These techniques may be used when streaming the media data to a radio access network (RAN), e.g., to a base station of the RAN, such that the base station can deliver the media data to a user equipment (UE) device via the RAN. In particular, the media data may be segmented into protocol data units (PDUs) and PDU Sets including a set of PDUs including media data that is to be presented at the same playback time. A server device or originating UE device may send a data burst to the UE device via the base station, where the data burst includes multiple PDUs (e.g., one or more PDU Sets). In addition, the server device/originating UE device may signal a size of the data burst (BSSize).

Per techniques of this disclosure, the server device/originating UE device may further signal an accuracy value for the size of the data burst, that is, for the current burst to which the size and accuracy values apply. The accuracy value may represent an absolute or relative accuracy, and the accuracy value may express a confidence interval for the size value or a standard deviation for the size value. The base station may use the size value and the accuracy value to allocate base station resources for receiving the data burst or subsequent data bursts.

In one example, a method of sending media data includes: sending a data burst including a set of protocol data units (PDUs) including media data via a network; and sending a size value representing a size of the data burst and an accuracy value representing an accuracy of the size value.

In another example, a device for sending media data includes: a memory configured to store media data; and a processing system implemented in circuitry and configured to: send a data burst including a set of protocol data units (PDUs) including media data via a network; and send a size value representing a size of the data burst and an accuracy value representing an accuracy of the size value.

In another example, a method of receiving media data, the method comprising: receiving, by a base station of a radio access network (RAN), a data burst including a set of protocol data units (PDUs) including media data via a network; receiving, by the base station of the RAN, a size value representing a size of the data burst and an accuracy value representing an accuracy of the size value; and allocating, by the base station, base station resources for the data burst according to the size value and the accuracy value.

In another example, a base station device of a radio access network (RAN) includes: a memory configured to store data of a data burst including a set of protocol data units (PDUs) including media data; and a processing system implemented in circuitry and configured to: receive a size value representing a size of the data burst and an accuracy value representing an accuracy of the size value; allocate base station resources for the data burst according to the size value and the accuracy value to form allocated base station resources; and use the allocated base station resources to receive the data burst via a network.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering.

FIG. 3 is a flowchart illustrating an example method of performing split rendering.

FIG. 4 is a conceptual diagram illustrating an example one-byte RTP Header Extension format for a data burst.

FIG. 5 is a conceptual diagram illustrating an example two-byte RTP Header Extension format for a data burst.

FIG. 6 is a block diagram illustrating an example set of network devices that may perform various aspects of the techniques of this disclosure.

FIG. 7 is a flowchart illustrating an example method of sending a data burst as well as a predicted size of the data burst and an accuracy of the predicted size per techniques of this disclosure.

FIG. 8 is a flowchart illustrating a method of receiving a current data burst by a base station device per techniques of this disclosure.

### DETAILED DESCRIPTION

In general, this disclosure describes techniques related to streaming of media data, such as audio data, video data, and/or extended reality (XR) media data. XR media data may include, for example, augmented reality (AR) media data, mixed reality (MR) media data, and/or virtual reality (VR) media data. When streaming such media data for an XR communication session, the media data may be partitioned into protocol data unit (PDUs). PDUs may be organized into PDU Sets, where a PDU set may include one or more PDUs that carry a payload of one unit of information generated at the application level, such as video frames, video slices, audio frames, XR media frames, or the like. PDUs of a PDU Set may be exchanged within a common quality of service (QoS) flow.

PDU Sets may be included on one or more network packets, which may be transmitted as a data burst. That is, the data burst may include one or more PDUs that are generated and sent by an originating device (e.g., a server device or a user equipment (UE) device) and received by a destination device (e.g., another UE device). In some examples, the destination device may be paired with a display device, such as an AR/MR/VR/XR headset. The destination device and the display device may be configured to perform split rendering.

A split rendering server (e.g., the destination UE device) may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may need to perform pose correction to modify the rendered data according to an actual pose of the user at the display time.

Per techniques of this disclosure, media data (e.g., AR/XR data) may be sent via RTP in a data burst including a set of protocol data units (PDU Set). Traffic characteristics of a data burst may be communicated in network metadata, such as in an RTP Header Extension. A data burst may represent a set of multiple PDUs generated and sent in a short period of time, e.g., per TS 23.501 clause 3.1. A sending device may determine the meaning of “a short period of time” for a data burst, e.g., based on an implementation of the sending device and/or data transmission. The characteristics may include a time gap between two adjacent data bursts and the size of each data burst. The characteristics may remain to some extent, even after the data bursts traverse a communication network. The traffic characteristic indication may help a radio access network (RAN) base station to schedule transmissions and/or to perform discontinuous reception (DRX) adaptation.

RTP header extensions may be used to communicate the data burst traffic characteristics, per the techniques of this disclosure. An existing RTP header extension for PDU Set marking may be enhanced, or a new RTP header extension may be dedicated to data burst traffic characteristics. Alternatively, other protocol headers may convey the data burst traffic characteristics, such as a QUIC header extension.

In some cases, a sending device may begin sending PDUs of a current data burst before the entire PDU Set for the current data burst has been formed. This may reduce latency associated with transmitting the PDUs of the PDU Set. However, this means that the exact size of the data burst cannot be determined when the data burst begins, because the PDU Set has not yet been fully formed. Therefore, per techniques of this disclosure, a sending device may predict a size of the data burst, and signal an accuracy value indicating an accuracy of the predicted size. In this manner, a base station or other receiving device may use the signaled size (predicted size) and the accuracy of the predicted size to, e.g., allocate resources to receive data of the data burst. For example, the base station may schedule a downstream UE device that is the destination of the data burst to remain active and receiving data until an amount of data equal to the predicted size, augmented by the accuracy value, has been received. The base station may further configure the UE device to disable reception circuitry after a configured period of time during which no data has been received but after having received an amount of data within the accuracy of the predicted burst size.

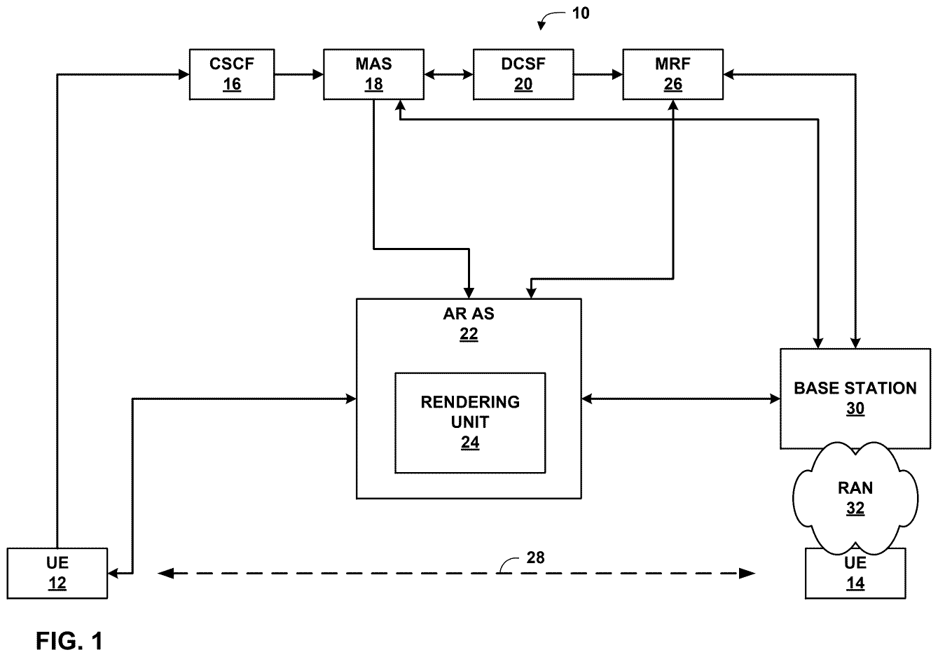

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, augmented reality application server (AR AS) 22, and base station 30 (e.g., an eNodeB or gNodeB). MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users'avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. In particular, AR media data (in the form of a data burst including one or more protocol data unit (PDU) Sets) may be sent to base station 30, which may provide the AR media data to UE 14 via radio access network (RAN) 32. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, such as media content 64, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data (e.g., media content 64) and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

As noted above, media data may be sent from UE 12 (or a server device, not shown in FIG. 1) to UE 14 via base station 30. Base station 30 is communicatively coupled to UE 14 via RAN 32. Per techniques of this disclosure, UE 12 may send a data burst to UE 14 via base station 30, where the data burst may include one or more PDU Sets. A data burst may be a set of multiple PDUs generated and sent in a short period of time, e.g., per Clause 3.1 of TS 23.501. In addition, UE 12 may send (and base station 30 may receive) traffic characteristics for the data burst. The characteristics may include a time gap between two adjacent bursts, the size of each data burst, or the like. The characteristics may remain relevant, to some extent, even after the data bursts traverse network 10. Base station 30 may use signaled characteristics to allocate resources of base station 30 for sending and receiving data of communication session 28. For example, base station 30 may use these signaled characteristics to perform scheduling and/or discontinuous reception (DRX) adaptation.

One relevant traffic characteristic is data burst size for a data burst. The data burst size may be signaled in a real-time transport protocol (RTP) Header Extension of a packet including data of the data burst. In some examples, an RTP Header Extension includes data representing a size of a subsequent data burst to the current data burst including the RTP Header Extension. That is, the signaled data burst size may represent a predicted size for the next data burst.

For the size of the data burst, prediction may be needed, because the size may vary based on whether the data to be transmitted has been generated by the time when an ordinal first packet of the data burst is to be transmitted. If all of the data has been generated, then the burst size can be accurately predicted. However, if not all of the data has been generated, then there may be prediction errors in the data burst size value. This could happen if UE 12 generates the packets for the data burst gradually (e.g., if the data burst includes multiple application data units, such as a video frame and an audio frame, in sequence). To minimize latency, UE 12 may transmit the first packet of the data burst without waiting for the data of the whole data burst to be generated.

It is important for network entities, such as base station 30 or other entities of RAN 32, to determine how accurate an indicated data burst size value is for the data burst. Thus, per techniques of this disclosure, UE 12 may further signal an accuracy of the predicted size of a current data burst. For example, UE 12 may signal the accuracy of the signaled (predicted) size of the current data burst in an RTP Header Extension of one or more packets of the current data burst, or an RTP Header Extension of a PDU Set marking packet. In this manner, base station 30 can more accurately allocate resources for communication session 28 using the signaled size value and accuracy value.

In some examples, UE 12 may signal, and base station 30 may receive, the accuracy value for the size of the data burst (BSSize). The accuracy of the size of the data burst may be indicated in a field of an RTP Header Extension. The accuracy value may be based on a standard deviation or a confidence interval (e.g., a 95% confidence interval). The accuracy value may represent an absolute error, in which case an indicated accuracy of y means +/−y units of data relative to the indicated BSSize value x. Thus, the accuracy value may give a range of the prediction: x+/−y units of data. For example, the indicated accuracy may have 8 bits, and the unit of data may be 32 bytes. Alternatively, the accuracy value may represent a relative error, where an indicated accuracy of a indicates +/−a of the indicated BSSize value x. That is, the accuracy value may indicate a range of the prediction: x*(1+/−a). For example, the indicated accuracy may have 8 bits and represent a fractional number with the decimal point to the left of the most significant bit, hence 01000000 may mean 0.25 in decimal.

The RTP Header Extension may be for a PDU Set marking with a new field for the accuracy value. When the data burst includes multiple PDU Sets, the BSSize and prediction accuracy value may be carried in an RTP Header Extension in the first PDU Set or in an RTP Header Extension in the last PDU Set. Alternatively, an RTP Header Extension for the data burst may include a new field for the accuracy value or accuracy information.

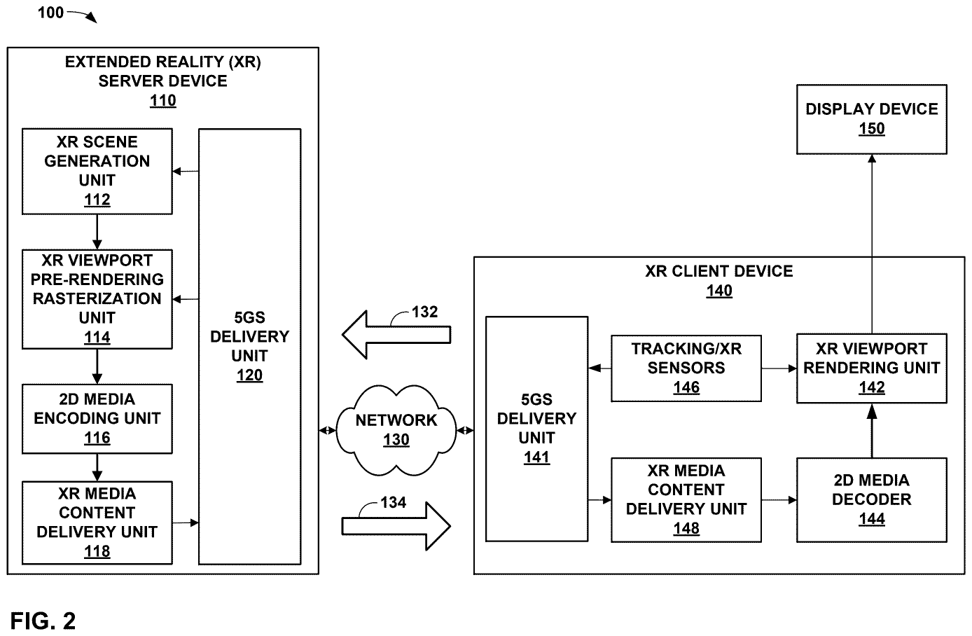

FIG. 2 is a block diagram illustrating an example computing system 100 that may perform split rendering. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

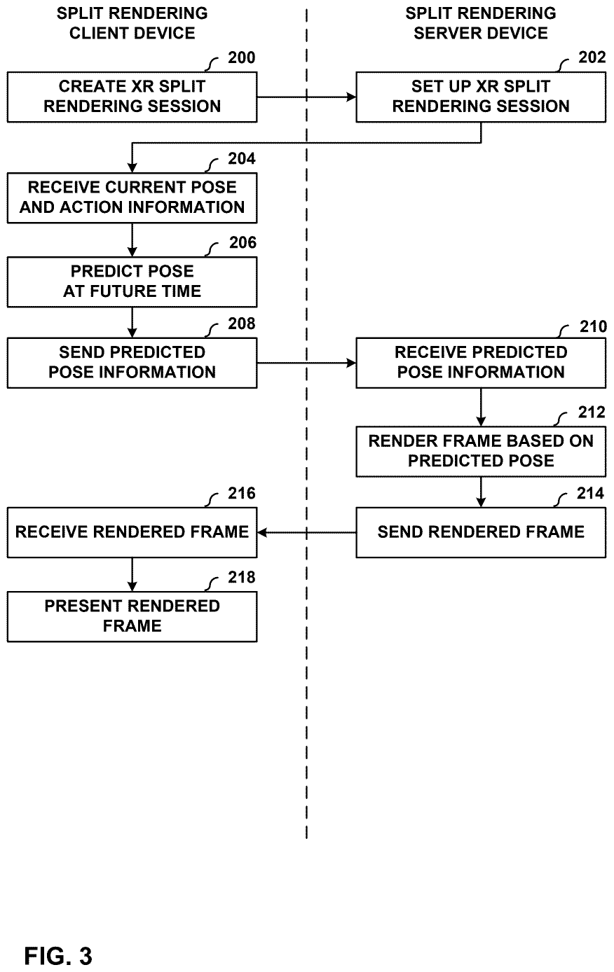

FIG. 3 is a flowchart illustrating an example method of performing split rendering. The method of FIG. 3 is performed by a split rendering client device, such as XR client device 140 of FIG. 2, in conjunction with a split rendering server device, such as XR server device 110 of FIG. 2.

Initially, the split rendering client device creates an XR split rendering session (200). As discussed above, creating the XR split rendering session may include, for example, sending device information and capabilities, such as supported decoders, viewport information (e.g., resolution, size, etc.), or the like. The split rendering server device sets up an XR split rendering session (202), which may include setting up encoders corresponding to the decoders and renderers corresponding to the viewport supported by the split rendering client device.

The split rendering client device may then receive current pose and action information (204). For example, the split rendering client device may collect XR pose and movement information from tracking/XR sensors (e.g., tracking/XR sensors 146 of FIG. 2). The split rendering client device may then predict a user pose (e.g., position and orientation) at a future time (206). The split rendering client device may predict the user pose according to a current position and orientation, velocity, and/or angular velocity of the user/a head mounted display (HMD) worn by the user. The predicted pose may include a position in an XR scene, which may be represented as an {X, Y, Z} triplet value, and an orientation/rotation, which may be represented as an {RX, RY, RZ, RW} quaternion value. The split rendering client device may send the predicted pose information (optionally), along with any actions performed by the user to the split rendering server device (208).

The split rendering server device may receive the predicted pose information (210) from the split rendering client device. The split rendering server device may then render a frame for the future time based on the predicted pose at that future time (212). For example, the split rendering server device may execute a game engine that uses the predicted pose at the future time to render an image for the corresponding viewport, e.g., based on positions of virtual objects in the XR scene relative to the position and orientation of the user's pose at the future time. The split rendering server device may then send the rendered frame to the split rendering client device (214).

The split rendering client device may then receive the rendered frame (216) and present the rendered frame at the future time (218). For example, the split rendering client device may receive a stream of rendered frames and store the received rendered frames to a frame buffer. At a current display time, the split rendering client device may determine the current display time and then retrieve one of the rendered frames from the buffer having a presentation time that is closest to the current display time.

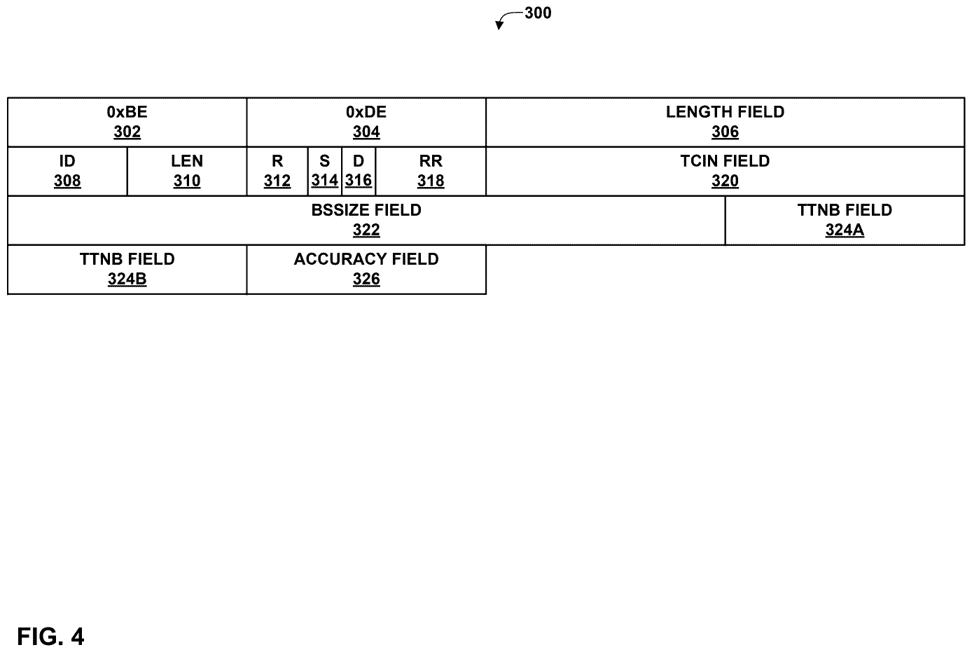

FIG. 4 is a conceptual diagram illustrating an example one-byte RTP Header Extension format 300 for a data burst. In this example, RTP header extension format 300 includes hex value 0xBE 302 (8 bits), hex value 0xDE 304 (8 bits), length field 306 (16 bits), identifier (ID) value 308 (4 bits), length (len) value 310 (4 bits), R bits 312 (2 bits), S bit 314, D bit 316, RR field 318 (4 bits), TCIN field 320 (16 bits), BSSize field 322 (24 bits), and TTNB fields 324A, 324B (total of 16 bits), and accuracy field 326 (8 bits). In this example, the value of S bit 314 may be set to 1 to indicate that the TTNB value of TTNB fields 324A, 324B corresponds to the first PDU of the burst, whereas the value of S bits 314 may be set to 0 to indicate that the TTNB value of TTNB fields 324A, 324B corresponds to the last PDU of the burst.

Per techniques of this disclosure, the one-byte RTP Header Extension format 300 of FIG. 4 may include an accuracy value for the BSSize (data burst size) value in accuracy field 326. That is, accuracy field 326 may include an accuracy value indicating how accurate the value of BSSize field 322 is for the current data burst.

In some examples, as an alternative, an ordinal first packet of the current data burst may include a burst size value in BSSize field 322, and a subsequent packet of the current data burst may include an accuracy value in the bits corresponding to BSSize field 322, such that accuracy field 326 is not explicitly included in the RTP Header Extension.

In some examples, as yet another alternative, a packet may include both an RTP Header Extension conforming to RTP Header Extension format 300 and a second RTP Header Extension including the accuracy value.

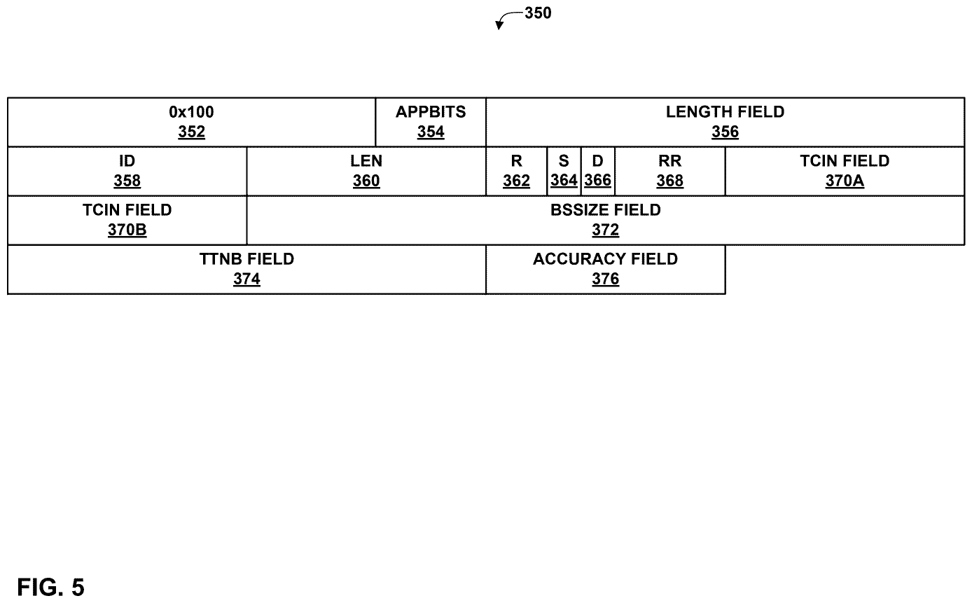

FIG. 5 is a conceptual diagram illustrating an example two-byte RTP Header Extension format 350 for a data burst. In this example, RTP header extension format 350 includes hex value 0x100 352 (12 bits), appbits 354 (4 bits), length field 356 (16 bits), ID value 358 (8 bits), len value 360 (8 bits), R bits 362 (2 bits), S bit 364, D bit 366, RR field 368 (4 bits), TCIN fields 370A, 370B (16 bits total), BSSize field 372 (24 bits), and TTNB field 374 (16 bits), and accuracy field 376 (8 bits). In this example, the value of S bit 364 may be set to 1 to indicate that the TNBD value corresponds to the first PDU of the burst, whereas the value of S bit 364 may be set to 0 to indicate that the TNBD value corresponds to the last PDU of the burst. Because R bits 362 are reserved, the expected value of R bits 362 may be 00, thus the value of R bits 362 in combination with the value of S bit 364 may be 001 to indicate that the TTNB value corresponds to the first PDU of the burst or 000 to indicate that the TTNB value corresponds to the last PDU of the burst.

Per techniques of this disclosure, the two-byte RTP Header Extension format of FIG. 5 may include an accuracy value for the BSSize (data burst size) value in accuracy field 376 as shown. That is, accuracy field 376 may include an accuracy value indicating how accurate the value of BSSize field 372 is for the current data burst.

In some examples, as an alternative, an ordinal first packet of the current data burst may include a burst size value in BSSize field 372, and a subsequent packet of the current data burst may include an accuracy value in the bits corresponding to BSSize field 372, such that accuracy field 376 is not explicitly included in the RTP Header Extension.

In some examples, as yet another alternative, a packet may include both an RTP Header Extension conforming to RTP Header Extension format 350 and a second RTP Header Extension including the accuracy value.

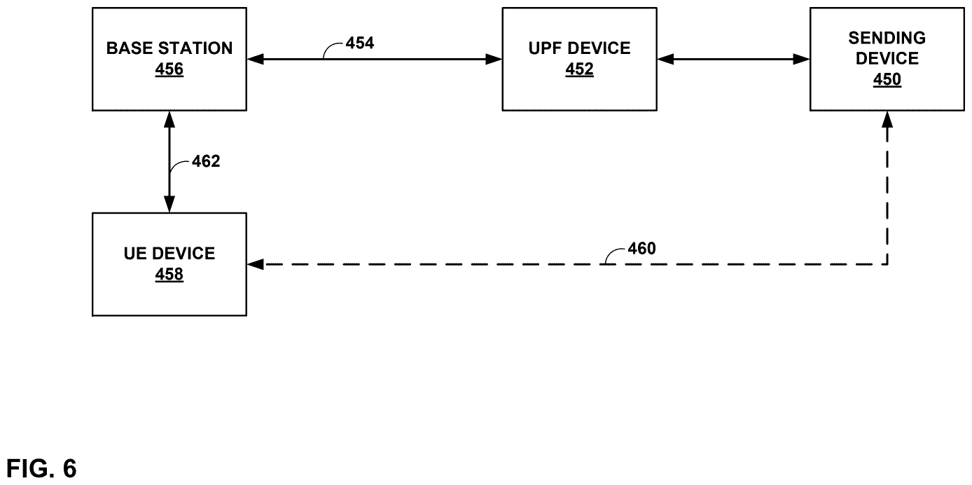

FIG. 6 is a block diagram illustrating an example set of network devices that may perform various aspects of the techniques of this disclosure. The example of FIG. 6 depicts sending device 450, user plane function (UPF) device 452, base station 456, and user equipment (UE) device 458. Sending device 450 may correspond to UE 12 or AR AS 22 of FIG. 1. UE device 458 may correspond to UE 14 of FIG. 1.

Sending device 450 (e.g., an application server (AS) device or another UE device) may obtain video data to be sent to UE device 458 via communication session 460. To send the video data to UE device 458, sending device 450 may encode the video data (or receive encoded video data from an encoding device, not shown in FIG. 6). Sending device 450 may encapsulate packets including encoded video data (e.g., encoded slices of frames of video data) to form real-time transport protocol (RTP) packets. Such RTP packets may correspond to PDUs of respective data bursts.

Sending device 450 may add an RTP header extensions to certain PDUs to indicate burst size data for a current data burst. For example, sending device 450 may add such RTP header extensions to ordinal first PDUs and/or to PDUs indicating a burst size update for the current data burst. As the RTP packets are formed, sending device 450 may send the RTP packets to UE device 458 via a network including UPF device 452. Although not shown in FIG. 6, there may be additional network devices between sending device 450 and UPF device 452, e.g., various network routing devices, gateways, bridges, switches, or the like.

UPF device 452 may receive the RTP packets from sending device 450 and form GTP-U tunneled packets. For example, UPF device 452 may encapsulate the RTP packets with respective GTP-U headers. Per techniques of this disclosure, UPF device 452 may extract the burst size data and accuracy data from the RTP header extensions of the RTP packets, e.g., from respective RTP header extensions. UPF device 452 may then form the GTP-U headers to include corresponding burst size data and accuracy data. UPF device 452 may send the GTP-U packets to base station 456 via network tunnel 454. Network tunnel 454 may include other network devices, such as network routing devices, configured to forward the GTP-U packets along network tunnel 454 to base station 456.

Base station 456 may receive the GTP-U packets and decapsulate the GTP-U packets to reproduce the RTP packets. Base station 456 may allocate resources to reception of the GTP-U packets based on the burst size data and accuracy data signaled in the GTP-U header. For example, base station 456 may instruct UE device 458 to disable data reception after the total amount of data corresponding to the burst size for the current data burst has been received for a period of time corresponding to a signaled time to next burst (e.g., TTNB or TNBD value) per techniques of this disclosure. Base station 456 may then send the RTP packets to UE device 458 via radio access network (RAN) connection 462.

UE device 458 may receive the RTP packets from base station 456 via RAN connection 462. In particular, UE device 458 may be a battery powered device, such as a cellphone. Thus, to preserve battery power, UE device 458 may disable reception of packets for communication session 460 via RAN connection 462 for idle period times indicated by the TNBD/TTNB values following reception of all data for the current data burst as indicated by the burst size data and accuracy data. For example, during idle period times, UE device 458 may power down reception circuitry, then power up the reception circuitry at the end of the idle period.

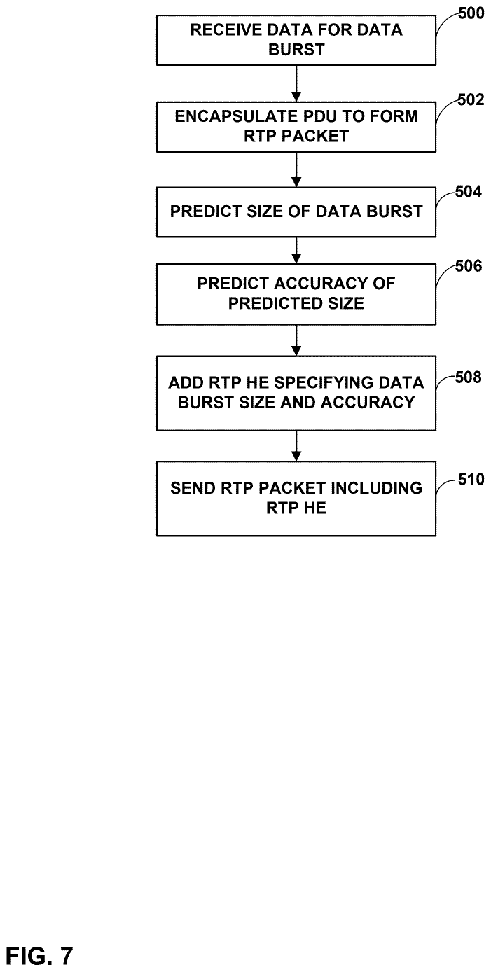

FIG. 7 is a flowchart illustrating an example method of sending a data burst as well as a predicted size of the data burst and an accuracy of the predicted size per techniques of this disclosure. The method of FIG. 7 may be performed by a sending device, such as UE 12 of FIG. 1, AR AS 22 of FIG. 1, or sending device 450 of FIG. 6. For purposes of example and explanation, the method of FIG. 7 is explained with respect to sending device 450 of FIG. 6.

Initially, sending device 450 may receive data for an upcoming data burst (500). The data may be, for example, video data, audio data, AR/XR data, or the like. Sending device 450 may generate or capture the data in real time, e.g., for an ongoing communication session with a destination device. The destination device may be, for example, UE 14 of FIG. 1, XR client device 140 of FIG. 2, or UE device 458 of FIG. 6. Sending device 450 may form PDUs of a PDU Set for the upcoming data burst using the received data, then encapsulate PDUs of the PDU Set into RTP packets (502) for transmission.

In addition, sending device 450 may predict a size of the data burst (504) and an accuracy of the predicted size (506). For example, sending device 450 may track statistics of received sets of data for historical data bursts, such as a size of a set of data to be sent and a corresponding size of the resulting PDUs for the set of data. From such data, sending device 450 may further predict size of PDUs and compare such predicted sizes to actual resulting PDU sizes, as well as track variances between the predicted sizes and the actual data burst sizes. Sending device 450 may maintain a simple moving average, exponential moving average, or other aggregate measure of the variances to track accuracies of predictions over time and use a current value of the aggregate measure as the accuracy value of the current data burst. In another example, a heuristic model may be used, where sending device 450 provides pose information and scene complexity information into the heuristic model, and the heuristic model outputs the size of the resulting data burst and the associated accuracy value.

Sending device 450 may then add an RTP header extension (HE) to the RTP packet specifying the predicted burst size and accuracy value for the current data burst (508). Alternatively, sending device 450 may send the predicted burst size in a first packet and the accuracy value in a subsequent packet. Alternatively, sending device 450 may add two distinct RTP header extensions to a packet, one RTP header extension including data for the predicted burst size and another RTP header extension including data for the accuracy value.

As noted above, the accuracy value may represent an absolute error or a relative error. An absolute error of +/−y may indicate that the signaled prediction size may have +/−y units of data. A relative error of a may indicate that, for a signaled prediction size x, the actual resulting burst size for the current burst is within x*(1+/−a).

Sending device 450 may then send the RTP packet to the destination device (510).

In this manner, the method of FIG. 7 represents an example of a method of sending media data, including: sending a data burst including a set of protocol data units (PDUs) including media data via a network; and sending a size value representing a size of the data burst and an accuracy value representing an accuracy of the size value.

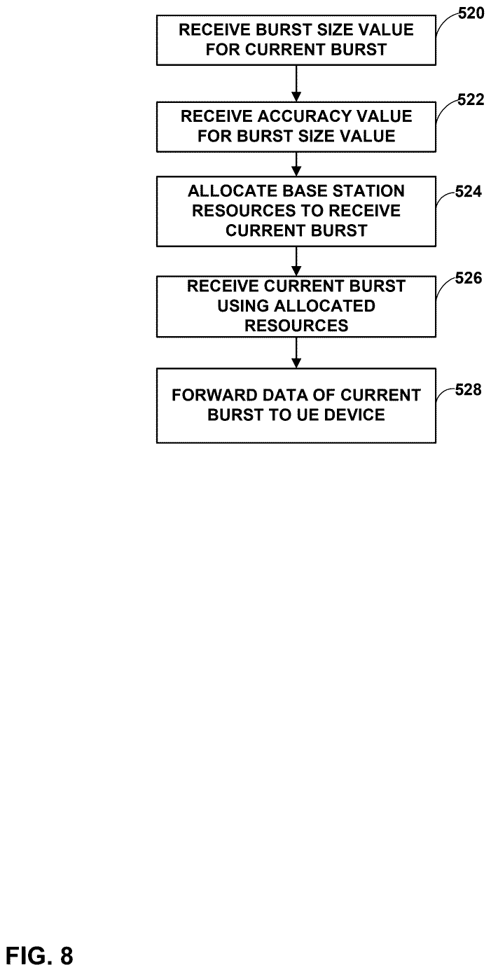

FIG. 8 is a flowchart illustrating a method of receiving a current data burst by a base station device per techniques of this disclosure. The method of FIG. 8 may be performed by a base station device, such as base station 30 of FIG. 1 or base station 456 of FIG. 6. For purposes of example and explanation, the method of FIG. 8 is explained with respect to base station 456 of FIG. 6.

Initially, base station 456 may receive a burst size value for a current data burst (520). Base station 456 may also receive an accuracy value for the burst size value (522). Such data may be included in GTP-U headers of one or more GTP-U tunneled packets that encapsulate respective RTP packets. As noted above, the accuracy value may represent an absolute error or a relative error. An absolute error of +/−y may indicate that the signaled prediction size may have +/−y units of data. A relative error of a may indicate that, for a signaled prediction size x, the actual resulting burst size for the current burst is within x*(1+/−a).

Base station 456 may then allocate resources to receive the current burst (524). For example, base station 456 may use the burst size and accuracy value to select a resource allocation type, perform a frequency domain resource assignment and/or a time domain resource assignment, determine a modulation and coding scheme, or the like. Additionally or alternatively, base station 456 may use the burst size and accuracy value to allocate slots and/or symbols within slots to a UE involved in a communication session. Additionally or alternatively, base station 456 may allocate resource blocks and/or resource block groups to the UE, configure subcarrier spacing, and/or configure bandwidth parts (BWPs) for the UE based on the burst size and accuracy value for a current data burst of the communication session that the UE is engaged in.

Base station 456 may then receive data of the current data burst using the allocated resources (526) and forward the data of the current data burst to a destination UE device (528). In particular, the PDUs of the current data burst may be encapsulated in GTP-U packets. Thus, base station 456 may decapsulate the PDUs from the GTP-U packets, in the form of RTP packets, and forward the RTP packets to the UE device (e.g., UE device 458 of FIG. 6).

In this manner, the method of FIG. 8 represents an example of a method of receiving media data, including: receiving, by a base station of a radio access network (RAN), a data burst including a set of protocol data units (PDUs) including media data via a network; receiving, by the base station of the RAN, a size value representing a size of the data burst and an accuracy value representing an accuracy of the size value; and allocating, by the base station, base station resources for the data burst according to the size value and the accuracy value.

Various examples of the techniques of this disclosure are summarized in the following clauses:
Clause 1: A method of sending media data, the method comprising: sending a data burst including a set of protocol data units (PDUs) including media data via a network; and sending a size value representing a size of the data burst and an accuracy value representing an accuracy of the size value.
Clause 2: The method of clause 1, wherein sending the data burst comprises sending one or more packets including the set of PDUs including media data.
Clause 3: The method of any of clauses 1 and 2, wherein sending the size value and the accuracy value comprises sending the size value in a first real-time transport protocol (RTP) header extension of a first header of a first packet and sending the accuracy value in a second RTP header extension of a second header of a second packet.
Clause 4: The method of clause 3, wherein the second packet comprises a PDU Set marking packet for the data burst.
Clause 5: The method of clause 4, wherein the PDU Set marking packet for the data burst comprises an ordinal first PDU Set for the data burst.
Clause 6: The method of clause 4, wherein the PDU Set marking packet for the data burst comprises an ordinal last PDU Set for the data burst.
Clause 7: The method of clause 1 and 2, wherein sending the size value comprises sending the size value in a first real-time transport (RTP) header extension of a first header of a first packet, and wherein sending the accuracy value comprises sending the accuracy value in a second RTP header extension for the data burst.
Clause 8: The method of any of clauses 1 and 2, wherein sending the size value and the accuracy value comprises sending the size value and the accuracy value in a real-time transport protocol (RTP) header extension of a header of a packet.
Clause 9: The method of clause 8, wherein the packet comprises a PDU Set marking packet for the data burst.
Clause 10: The method of clause 9, wherein the PDU Set marking packet for the data burst comprises an ordinal first PDU Set for the data burst.
Clause 11: The method of clause 9, wherein the PDU Set marking packet for the data burst comprises an ordinal last PDU Set for the data burst.
Clause 12: The method of clause 1 and 2, wherein sending the size value and the accuracy value comprises sending the size value and the accuracy value in a real-time transport (RTP) header for the data burst.
Clause 13: The method of any of clauses 1-12, further comprising calculating the accuracy value as a standard deviation of the size of the data burst.
Clause 14: The method of any of clauses 1-12, further comprising calculating the accuracy value as a confidence interval for the size of the data burst.
Clause 15: The method of any of clauses 1-14, wherein the accuracy value indicates an absolute error of the size value relative to a predicted size value.
Clause 16: The method of any of clauses 1-14, wherein the accuracy value indicates a relative error of the size value relative to a predicted size value.
Clause 17: The method of any of clauses 1-16, wherein the method is performed by a server device.
Clause 18: The method of any of clauses 1-16, wherein the method is performed by a user equipment (UE) device.
Clause 19: The method of clause 18, wherein the UE device comprises a first UE device that is engaged in a communication session with a second UE device.
Clause 20: The method of clause 19, wherein the communication session comprises an extended reality (XR) communication session including the media data.
Clause 21: A method of receiving media data, the method comprising: receiving, by a base station of a radio access network (RAN), a data burst including a set of protocol data units (PDUs) including media data via a network; receiving, by the base station of the RAN, a size value representing a size of the data burst and an accuracy value representing an accuracy of the size value; and allocating, by the base station, base station resources for the data burst according to the size value and the accuracy value.
Clause 22: The method of clause 21, wherein allocating the base station resources comprises allocating resources for at least one of scheduling reception of the data burst or for performing discontinuous reception (DRX) adaptation.
Clause 23: The method of any of clauses 21 and 22, wherein receiving the data burst comprises receiving one or more packets including the set of PDUs including media data.
Clause 24: The method of any of clauses 21-23, wherein receiving the size value and the accuracy value comprises receiving the size value and the accuracy value in a real-time transport protocol (RTP) header extension of a header of a packet.
Clause 25: The method of clause 24, wherein the packet comprises a PDU Set marking packet for the data burst.
Clause 26: The method of clause 25, wherein the PDU Set marking packet for the data burst comprises an ordinal first PDU Set for the data burst.
Clause 27: The method of clause 25, wherein the PDU Set marking packet for the data burst comprises an ordinal last PDU Set for the data burst.
Clause 28: The method of clause 24, wherein receiving the size value and the accuracy value comprises receiving the size value and the accuracy value in a real-time transport protocol (RTP) header extension for the data burst.
Clause 29: The method of any of clauses 21-28, wherein the accuracy value represents a standard deviation of the size of the data burst.
Clause 30: The method of any of clauses 21-28, wherein the accuracy value represents a confidence interval for the size of the data burst.
Clause 31: The method of any of clauses 21-30, wherein the accuracy value indicates an absolute error of the size value relative to a predicted size value.
Clause 32: The method of any of clauses 21-30, wherein the accuracy value indicates a relative error of the size value relative to a predicted size value.
Clause 33: The method of any of clauses 21-32, further comprising sending the media data to a user equipment (UE) device via the RAN.
Clause 34: A device for retrieving media data, the device comprising one or more means for performing the method of any of clauses 1-33.
Clause 35: The device of clause 34, wherein the one or more means comprise a processing system implemented in circuitry.
Clause 36: The device of clause 34, wherein the device comprises at least one of: an integrated circuit; a microprocessor; or a wireless communication device.
Clause 37: A device for sending media data, the device comprising: means for sending a data burst including a set of protocol data units (PDUs) including media data via a network; and means for sending a size value representing a size of the data burst and an accuracy value representing an accuracy of the size value.
Clause 38: A base station device of a radio access network (RAN) for receiving media data, the base station device comprising: means for receiving a data burst including a set of protocol data units (PDUs) including media data via a network; means for receiving a size value representing a size of the data burst and an accuracy value representing an accuracy of the size value; and means for allocating base station resources for the data burst according to the size value and the accuracy value.
Clause 39: A method of sending media data, the method comprising: sending a data burst including a set of protocol data units (PDUs) including media data via a network; and sending a size value representing a size of the data burst and an accuracy value representing an accuracy of the size value.
Clause 40: The method of clause 39, wherein sending the data burst comprises sending one or more packets including the set of PDUs including media data.
Clause 41: The method of clause 39, wherein sending the accuracy value comprises sending a packet including a Real-time Transport Protocol (RTP) header extension, the RTP header extension including the accuracy value.
Clause 42: The method of clause 41, wherein the packet comprises a PDU Set marking packet for the data burst.
Clause 43: The method of clause 42, wherein the PDU Set marking packet for the data burst comprises an ordinal first PDU Set for the data burst.
Clause 44: The method of clause 42, wherein the PDU Set marking packet for the data burst comprises an ordinal last PDU Set for the data burst.
Clause 45: The method of clause 41, wherein the RTP header extension further includes the size value.
Clause 46: The method of clause 41, wherein the RTP header extension comprises a second RTP header extension, and wherein sending the size value comprises sending a first RTP header extension of the packet, the first RTP header extension including the size value.
Clause 47: The method of clause 41, wherein the packet comprises a second packet, and wherein sending the size value comprises sending a first packet including an RTP header extension including the size value.
Clause 48: The method of clause 39, further comprising calculating the accuracy value as a standard deviation of the size of the data burst.
Clause 49: The method of clause 39, further comprising calculating the accuracy value as a confidence interval for the size of the data burst.
Clause 50: The method of clause 39, wherein the accuracy value indicates at least one of an absolute error of the size value relative to a predicted size value or a relative error of the size value relative to the predicted size value.
Clause 51: A device for sending media data, the device comprising: a memory configured to store media data; and a processing system implemented in circuitry and configured to: send a data burst including a set of protocol data units (PDUs) including media data via a network; and send a size value representing a size of the data burst and an accuracy value representing an accuracy of the size value.
Clause 52: The device of clause 51, wherein the device comprises a server device.
Clause 53: The device of clause 51, wherein the device comprises a user equipment (UE) device.
Clause 54: The device of clause 53, wherein the UE device comprises a first UE device that is engaged in a communication session with a second UE device, and wherein the first UE device is configured to send the data burst, the size value, and the accuracy value to the second UE device.
Clause 55: A method of receiving media data, the method comprising: receiving, by a base station of a radio access network (RAN), a data burst including a set of protocol data units (PDUs) including media data via a network; receiving, by the base station of the RAN, a size value representing a size of the data burst and an accuracy value representing an accuracy of the size value; and allocating, by the base station, base station resources for the data burst according to the size value and the accuracy value.
Clause 56: The method of clause 55, wherein allocating the base station resources comprises allocating resources for at least one of scheduling reception of the data burst or for performing discontinuous reception (DRX) adaptation.
Clause 57: The method of clause 55, wherein receiving the accuracy value comprises receiving the accuracy value in a real-time transport protocol (RTP) header extension of a header of a packet.
Clause 58: The method of clause 57, wherein the packet comprises a PDU Set marking packet for the data burst.
Clause 59: The method of clause 58, wherein the PDU Set marking packet for the data burst comprises an ordinal first PDU Set for the data burst.
Clause 60: The method of clause 58, wherein the PDU Set marking packet for the data burst comprises an ordinal last PDU Set for the data burst.
Clause 61: The method of clause 57, wherein the RTP header extension further includes the size value.
Clause 62: The method of clause 57, wherein the RTP header extension comprises a second RTP header extension, and wherein receiving the size value comprises receiving a first RTP header extension of the packet, the first RTP header extension including the size value.
Clause 63: The method of clause 55, wherein the accuracy value represents at least one of a standard deviation of the size of the data burst, a confidence interval for the size of the data burst, an absolute error of the size value relative to a predicted size value, or a relative error of the size value relative to a predicted size value.
Clause 64: The method of clause 55, further comprising sending the media data to a user equipment (UE) device via the RAN.
Clause 65: A base station device of a radio access network (RAN), the base station device comprising: a memory configured to store data of a data burst including a set of protocol data units (PDUs) including media data; and a processing system implemented in circuitry and configured to: receive a size value representing a size of the data burst and an accuracy value representing an accuracy of the size value; allocate base station resources for the data burst according to the size value and the accuracy value to form allocated base station resources; and use the allocated base station resources to receive the data burst via a network.
Clause 66: The base station device of clause 65, wherein to allocate the base station resources, the processing system is configured to allocate resources for at least one of scheduling reception of the data burst or for performing discontinuous reception (DRX) adaptation.
Clause 67: The base station device of clause 65, wherein to receive the accuracy value, the processing system is configured to receive the accuracy value in a real-time transport protocol (RTP) header extension of a header of a packet.
Clause 68: The base station device of clause 67, wherein the packet comprises a PDU Set marking packet for the data burst.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of sending media data, the method comprising:
sending a data burst including a set of protocol data units (PDUs) including media data via a network; and
sending a size value representing a size of the data burst and an accuracy value representing an accuracy of the size value.

2. The method of claim 1, wherein sending the data burst comprises sending one or more packets including the set of PDUs including media data.

3. The method of claim 1, wherein sending the accuracy value comprises sending a packet including a Real-time Transport Protocol (RTP) header extension, the RTP header extension including the accuracy value.

4. The method of claim 3, wherein the packet comprises a PDU Set marking packet for the data burst.

5. The method of claim 4, wherein the PDU Set marking packet for the data burst comprises an ordinal first PDU Set for the data burst.

6. The method of claim 4, wherein the PDU Set marking packet for the data burst comprises an ordinal last PDU Set for the data burst.

7. The method of claim 3, wherein the RTP header extension further includes the size value.

8. The method of claim 3, wherein the RTP header extension comprises a second RTP header extension, and wherein sending the size value comprises sending a first RTP header extension of the packet, the first RTP header extension including the size value.

9. The method of claim 3, wherein the packet comprises a second packet, and wherein sending the size value comprises sending a first packet including an RTP header extension including the size value.

10. The method of claim 1, further comprising calculating the accuracy value as a standard deviation of the size of the data burst.

11. The method of claim 1, further comprising calculating the accuracy value as a confidence interval for the size of the data burst.

12. The method of claim 1, wherein the accuracy value indicates at least one of an absolute error of the size value relative to a predicted size value or a relative error of the size value relative to the predicted size value.

13. A device for sending media data, the device comprising:
a memory configured to store media data; and
a processing system implemented in circuitry and configured to:
send a data burst including a set of protocol data units (PDUs) including media data via a network; and
send a size value representing a size of the data burst and an accuracy value representing an accuracy of the size value.

14. The device of claim 13, wherein the device comprises a server device.

15. The device of claim 13, wherein the device comprises a user equipment (UE) device.

16. The device of claim 15, wherein the UE device comprises a first UE device that is engaged in a communication session with a second UE device, and wherein the first UE device is configured to send the data burst, the size value, and the accuracy value to the second UE device.

17. A method of receiving media data, the method comprising:
receiving, by a base station of a radio access network (RAN), a data burst including a set of protocol data units (PDUs) including media data via a network;
receiving, by the base station of the RAN, a size value representing a size of the data burst and an accuracy value representing an accuracy of the size value; and
allocating, by the base station, base station resources for the data burst according to the size value and the accuracy value.

18. The method of claim 17, wherein allocating the base station resources comprises allocating resources for at least one of scheduling reception of the data burst or for performing discontinuous reception (DRX) adaptation.

19. The method of claim 17, wherein receiving the accuracy value comprises receiving the accuracy value in a real-time transport protocol (RTP) header extension of a header of a packet.

20. The method of claim 19, wherein the packet comprises a PDU Set marking packet for the data burst.
